(19) United States
(12) Patent Application Publication
(10) Pub. No.: US 2005/0107148 A1
(43) Pub. Date: May 19, 2005

(54) Casino game with multiple playing modes and wagering options (Texas Hold 'Em)

(75) Inventor: Derek J. Webb, Derby (GB)

Correspondence Address: NIXON & VANDERHYE, PC, 1100 N GLEBE ROAD, 8TH FLOOR, ARLINGTON, VA, 22201-4714, US

(73) Assignee: Prime Table Games LLC, Las Vegas, NV (US)

(21) Appl. No.: 11/011,377

(22) Filed: Dec. 15, 2004

Related U.S. Application Data
(63) Continuation-in-part of application No. 10/261,784, filed on Oct. 2, 2002.
Application No. 10/261,784 is a continuation-in-part of application No. 09/589,202, filed on Jun. 8, 2000, now Pat. No. 6,503,145.

(51) Int. Cl. A63F 13/00

(52) U.S. Cl. 463/13

(57) ABSTRACT

A house banked casino game simulates play of Texas Hold'Em. Each player places a competition wager, which is without a house advantage, and each player places a proposition wager. Hands of playing cards are dealt to each player, and at least one least community card is dealt to a community card area. The competition wager is resolved according to a poker rank of one player hand against a poker rank of another player hand, and the proposition wager is resolved according to the poker rank of each player hand against a payout scale. The rules are simple to execute and play eliminating skill decisions, thereby appealing to average or inexperienced players. The proposition wager further increases player interest by providing a chance for a high payout.

### CROSS-REFERENCES TO RELATED APPLICATIONS

This application is a continuation-in-part (CIP) of U.S. patent application Ser. No. 10/261,784, filed Oct. 2, 2002; which is a continuation-in-part (CIP) of U.S. patent application Ser. No. 09/589,202, filed Jun. 8, 2000, now U.S. Pat. No. 6,503,145, the entire contents of which are hereby incorporated by reference in this application.

### STATEMENT REGARDING FEDERALLY SPONSORED RESEARCH OR DEVELOPMENT

(NOT APPLICABLE).

### BACKGROUND OF THE INVENTION

The present invention relates to a casino game incorporating multiple playing modes and multiple wagering options and, more particularly, to a casino poker game that includes modes of play with no casino advantage.

Casino operators are continuously searching for ways to make casino table games more attractive and player friendly. New poker derivatives such as Caribbean Stud, Let-it-Ride, Pai Gow Poker, and Three Card Poker have made a significant contribution; however, many traditional players still regard these games as having too high a house advantage. Therefore, there would be a significant market for a poker derivative game where the house advantage was less apparent. Ideally, a beneficial innovation could include the implementation of a game incorporating bets with no house advantage.

Texas Hold 'Em has become popular over the last several years due to its simplicity, the ability to accommodate a higher number of players per table, and ESPN's televised coverage of the World Series of Poker. The game is played so that each player has the use of seven cards in order to form a five card poker hand. The player having the highest poker hand is the game winner. Hands are ranked in standard poker fashion, i.e. royal flush, straight flush, four of a kind, full house, flush, straight, three of a kind, two pair, one pair, and high card, in descending order.

In Texas Hold Em each player receives two cards face down. Additionally, there are five community cards dealt face up. The term “community card” refers to a non-player specific card that is exposed (face up) and available for use by any of the players in order to form a poker hand. Each player is enabled to use seven cards (i.e. the two concealed cards held by the player, plus the five community cards that are available to each player).

In Texas Hold Em the cards are dealt sequentially so that each player initially receives two cards face down, after which the five community cards are dealt face up. Rounds of betting occur at certain times during the course of the deal, usually after the two face down cards have been dealt, then after the third community card has been dealt, then after the fourth community card has been dealt, and finally after the fifth community card has been dealt. Thus, there are four rounds of betting (in addition to an ante prior to the cards being dealt).

There have been many attempts to derive a house-banked Texas Hold 'Em game for casino play, but with little success, some of which include Casino Hold'Em, Wild Hold'Em Fold'Em, Big Raise Hold'Em, Colorado Hold'Em, All-In Hold'Em, Fast Action Hold'Em and Texas Bonus Hold'Em. There are also other games using some aspect of Hold'Em, namely High Country Poker, Texas Shoot Out and Flip Flop Poker. Virtually all of these games are essentially games where the competition wagers on a player hand are against the dealer house hand. Only three of these games, Texas Bonus Hold'Em, Casino Hold,Em and All-In Hold'Em include the aspect of all community cards being dealt as in Hold'Em, with at least one bet option during play. Flip Flop Poker allows one optional wager of a fixed amount based on player hand against other player hands.

In actual card room Hold'Em, all player wagers are against other players. Players use skills of poker judgment to determine whether to remain in the game at each betting round. Ultimately one player wins the pot, unless there is a split pot based on equal hands.

To transform Hold'Em into a house banked casino game is not easy. Firstly, when casino games incorporate skill levels, then experienced players minimize the house advantage, whereas inexperienced players suffer a higher house advantage due to their inferior play. An obvious example is Blackjack, a game that very skilled players are able to actually win at, although the majority of players lose significantly more than they should if they just applied basic correct strategy. A new game should minimize the skill factor in order to have maximum appeal to the maximum number of players.

Secondly, a casino game is more attractive to more players if there are multiple simultaneous winners. This possibility is excluded in card room Hold'Em. The previous casino versions of Hold'Em as described above have been unable to incorporate the player versus player aspect, because of the desire to have multiple winners in a hand.

### BRIEF SUMMARY OF THE INVENTION

In order to capitalize on the current popularity of Texas Hold'Em, it would be desirable to provide a house-banked Texas Hold'Em game for casino play that overcomes the drawbacks with prior games that have not succeeded in the market. It also would be desirable to provide such a game with simple rules and a reasonable house advantage, including wagers without any house advantage.

The innovative method of the present invention eliminates the first problem discussed above by making the play of each pot mandatory and so the skill aspect is eliminated. The present invention eliminates the second problem by creating three separate player pots, which three different players may win a pot each. An optional method of allowing the dealer to participate against wagers above the minimum wager placed further increases the aspect of multiple win opportunities. For example a high stakes player may lose against another player but win the surplus stakes against the dealer.

The invention thus proposes a casino version of Texas Hold'Em. In a first playing mode, each player places three equal competition wagers, a first wager for the best 2-card hand, a second wager for the best 5-card hand after the community card flop (third, fourth, and fifth cards), and a third wager for the best 5-card hand after the turn (sixth card) and the river (seventh card), also community cards. A compulsory fourth wager is a proposition wager against a typical 7-card scale with payouts for 5-card hands exceeding a predetermined rank (such as two pair). There is no house advantage or commission for wagers one through three, and a reasonable house advantage is built into the proposition (fourth) wager.

The casino game according to the first playing mode simulates a player against player Texas Hold'Em game while providing a reasonable house advantage for casino viability. With a single player, the dealer may also act as a player. The proposition wager offers players an opportunity for a high payout for premium hands, which adds excitement to the game. Still further, by requiring all four wagers to participate in the game, each player will always be in the game, and game play is simplified.

In a second playing mode, players make only two wagers being a competition wager on all seven cards (each player's 2-card hand plus five community cards) against the dealer and the proposition wager against the 7-card scale.

### BRIEF DESCRIPTION OF THE DRAWINGS

These and other aspects and advantages of the present invention will be described in detail with reference to the accompanying drawings, in which:

FIG. 1 is a plan view of the table layout according to a first playing mode of the present invention;

FIG. 2 is a plan view of the table layout according to a second playing mode of the present invention; and

FIG. 3 is a block diagram illustrating the structure effecting game play according to the apparatus of the present invention.

### DETAILED DESCRIPTION OF THE INVENTION

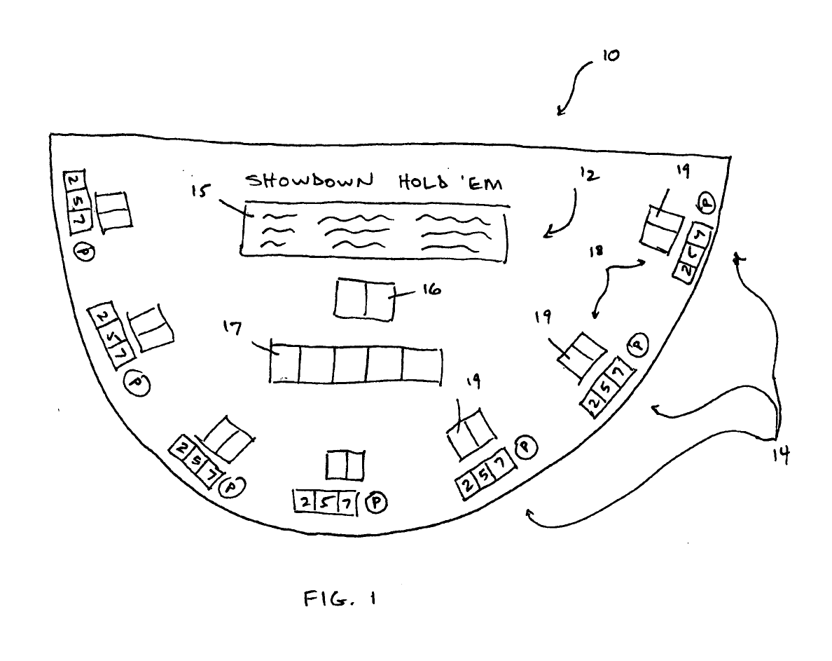

FIG. 1 is a plan view of an exemplary layout 10 for the game according to a first playing mode of the present invention. The layout 10 includes a dealer area 12 and a plurality of player areas 14. Although FIG. 1 shows six player areas 14, as many as twenty (20) players can participate in the game at a time. In preferred embodiments, the table layout 10 may include anywhere between seven and ten player areas 14, although seven player areas 14 is most preferred.

The dealer area 12 lists rules of play 15 and includes a dealer hand area 16 and a community card area 17. In one playing mode, the dealer acts as a player and receives a 2-card hand from the initial deal along with the players. Alternatively, the dealer may act as a player only when a single player is playing the game, or against only the highest stake player in the game. Each player station 14 includes a wager area 18 and a player hand area 19. The wager area 18 includes spaces for four compulsory wagers, including a player hand wager 2, a flop wager 5, a turn and river wager 7, and a proposition wager P.

In game play, each player is required to place equal wagers in all four spaces (2, 5, 7 and P) of the wager area 18. In some playing modes, the players may be permitted to bet a higher amount for the proposition wager P, for example, up to an aggregate total of wagers 1-3 (i.e., 2+5+7).

In one operating mode, players play against each other based on the lowest amount wagered by a player at the table. The remainder of wagers exceeding the lowest amount is resolved against the house. For example, assume two players wager $10 and $15, respectively, for each of the four wagers. The player wagering $15 has $10 at risk against the other player and $5 at risk against the house. Thus, all amounts equal to the lowest wager are pooled for each round, and all surplus wagers play against the house. In an alternative operating mode, the game rules may require that all player wagers are equal, except possibly the proposition wager P. In still another operating mode, multiple pots may be pooled, and only the highest stake player surplus plays against the house. For example, assume three players wager $10, $15 and $20, respectively, for each of the four wagers. A first pooled pot includes $10 from each player, and all players play against each other to win the pot; a second pooled pot includes $5 each from the second and third players, who play against each other for the second pooled pot; and the third player's $5 surplus is played against the house.

After all wagers have been placed, the dealer deals a 2-card hand to each player, face up in the player hand areas 19. The first wager 2 is resolved by paying the pooled wagers to the player with the best 2-card hand. In the preferred operating mode, the surplus wagers are also resolved against the house by comparing them to the dealer's hand. The dealer then deals three cards face up into the community card area 17 (the “flop”), and the second wager 5 is similarly resolved in favor of the player with the best 5-card hand (and in favor of those beating the house in the event of surplus wagers). Finally, the dealer deals a fourth card into the community card area 17 (the “turn”) and a fifth card into the community card area (the “river”). The third wager 7 is then similarly resolved in favor of the player with the best 5-card hand using any combination of the community cards and the player's 2-card hand (and in favor of those beating the house in the event of surplus wagers). Since these wagers are played player against player (or head-to-head against the dealer for surplus wagers), it will be appreciated that the first, second and third wagers (2, 5 and 7) are without any house advantage.

Tied or pushed hands are typically resolved by splitting the pooled wagers or “pot.” With an odd amount of chips in the pot, in a preferred operating mode, the odd amount can be paid to the first player left of the “button,” which is the sequentially rotating start position for dealing hands to players and resolving player wagers. Alternatively, the odd amount can stay in the pot for the next round (either the next wager or even a next hand) with the odd amount broken into $1 increments; or, the odd amount can be broken into $1 increments in each round, with any extra chips being held over to the next round or hand. Still another alternative awards the odd chip using the highest card in the pushed players' 2-card hands, with cards of a same rank being determined by suit preference, for example, Clubs, Diamonds, Hearts, Spades (i.e., Ace of Clubs beats Ace of Diamonds, etc.).

After the 2, 5 and 7 wagers are resolved, the proposition wagers P are resolved based on each player's best 5-card poker ranking achieved using the player's 2-card hand and the five community cards dealt in the community card area 17 during the course of the game. This wager has a reasonable built-in house advantage. An example of a suitable payout scale is as follows:

| | |
|---|---|
| Three of a Kind | 3 to 1 |
| Straight | 4 to 1 |
| Flush | 5 to 1 |
| Full House | 6 to 1 |
| Four of a Kind | 40 to 1 |
| Straight Flush | 200 to 1 |

Preferably, a single standard fifty-two card deck of playing cards is used using conventional poker combinations. In alternative arrangements, multi-deck playing modes could be contemplated, and other means for determining hand ranks could be used, such as numerical totals with a blackjack or baccarat count system. Still other alternatives could utilize dice with poker values or numerical values applying.

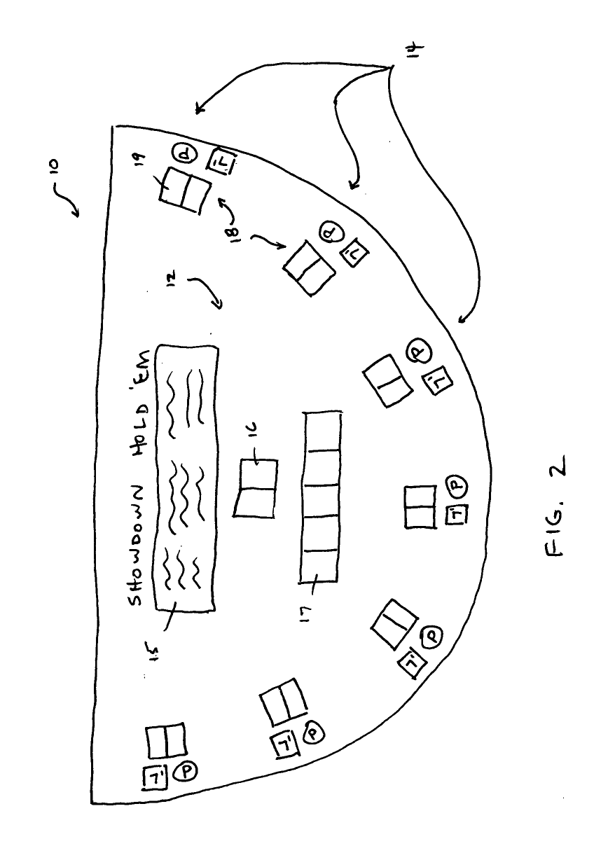

In an alternative playing mode, with reference to FIG. 2, players make only two wagers being a competition wager 7′ on all seven cards (including each player's two-card hand and the five community cards) against the dealer only, and the proposition wager P, preferably of an equal amount. The competition wagers 7′ are resolved based on a comparison of each player's best 5-card poker hand (using the seven available cards) with the dealer's best 5-card poker hand, with winning hands being paid 1 to 1. In this manner, like the first playing mode, the competition wager is without a house advantage. The proposition wagers P are resolved as in the first playing mode.

As would be apparent to those skilled in the relevant art, the invention can be embodied in a wide variety and forms of media such as, but not limited to, single player slot video machines, multi-player slot video machines, electronic games and devices, lottery terminals, scratch-card formats, software, as well as in-flight, home and Internet entertainment. In addition, the invention can be readily implemented as a computer program product (e.g., floppy disk, compact disc, etc.) comprising a computer readable medium having control logic recorded therein to implement the features of the invention as described. Control logic can be loaded into the memory of a computer and executed by a central processing unit (CPU) to perform the operations described herein.

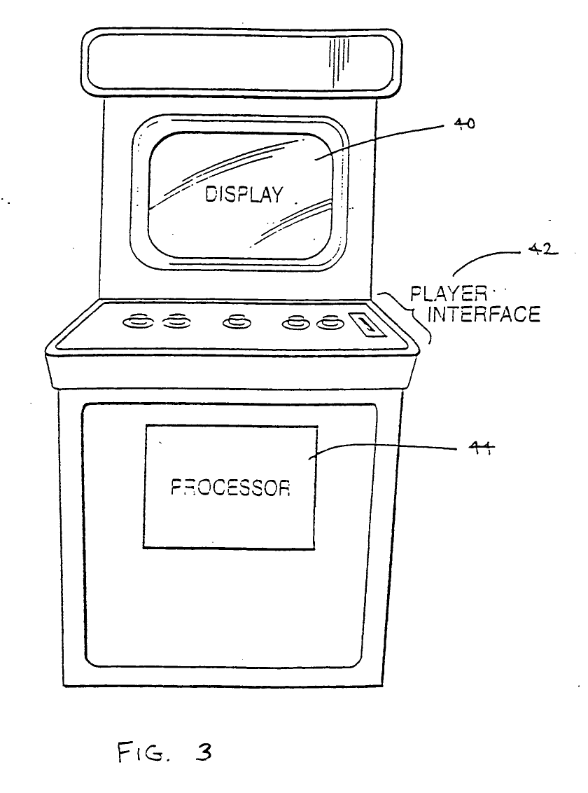

In this context, referring to FIG. 3, a block diagram is illustrated showing the components of an apparatus configured for playing the game according to the invention. The apparatus includes a display 40, a player interface 42, and circuitry 44 for effecting game play and including structure for receiving wagers in one or more playing modes and dealing hands according to the rules of the game. The processing circuit 44 effects game play according to game rules and resolves wagers based on a comparison of player hand to other computer player hands and/or a computer dealer hand as well as the payout scale.

With the game according to the present invention, a house-banked Texas Hold'Em game is provided for casino play with simple rules and a reasonable house advantage, including wagers without any house advantage. A proposition wager is the sole source of the reasonable house advantage, which adds to player excitement with the possibility of a high payout for a premium hand. Additionally, all players stay in for every wager round so the game is easier to play and less intimidating for beginners.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of playing a casino game, comprising:
(a) receiving a competition wager from each player, the competition wager being without a house advantage;
(b) receiving a proposition wager from each player;
(c) a dealer dealing hands of playing cards to each player and at least one least community card to a community card area;
(d) resolving the competition wager according to a poker rank of one player hand against a poker rank of another player hand; and
(e) resolving the proposition wager according to the poker rank of each player hand against a payout scale.

2. A method according to claim 1, wherein the dealer is a player, and wherein step (d) is practiced by comparing the poker rank of each player hand against the dealer.

3. A method according to claim 2, wherein step (c) is practiced by dealing 2-card hands to each player and five community cards to the community card area.

4. A method according to claim 3, wherein step (d) is practiced by paying 1 to 1 on the competition wager if the player's best 5-card poker hand from the player's 2-card hand and the five community cards exceeds that of the dealer.

5. A method according to claim 4, wherein step (e) is practiced by paying a payout if the player's best 5-card poker hand exceeds a predetermined poker rank.

6. A method according to claim 1, wherein step (c) is practiced by dealing a two-card hand to each player as a first event and dealing three community cards to the community card area as a second event.

7. A method according to claim 6, wherein step (a) is practiced by receiving a first competition wager for the first event and a second competition wager for the second event.

8. A method according to claim 7, wherein the first and second competition wagers are of equal value.

9. A method according to claim 7, wherein step (d) is practiced by (d-1) pooling player wagers for the first event and paying the pooled player wagers to the player having the highest 2-card poker rank, and (d-2) pooling player wagers for the second event and paying the pooled player wagers to the player having the highest 5-card poker rank using the player hands and the community cards.

10. A method according to claim 9, wherein steps (d-1) and (d-2) are practiced by pooling player wagers equal to an amount of a lowest player wager for each event, respectively, wherein wagers exceeding the lowest player wager are played against the dealer.

11. A method according to claim 9, wherein all player wagers are equal.

12. A method according to claim 6, wherein step (c) is practiced by dealing an additional two community cards to the community card area as a third event.

13. A method according to claim 12, wherein step (a) is practiced by receiving a first competition wager for the first event, a second competition wager for the second event, and a third competition wager for the third event.

14. A method according to claim 13, wherein the first, second and third competition wagers are of equal value.

15. A method according to claim 13, wherein step (d) is practiced by (d-1) pooling player wagers for the first event and paying the pooled player wagers to the player having the highest 2-card poker rank, (d-2) pooling player wagers for the second event and paying the pooled player wagers to the player having the highest 5-card poker rank using the player hands and the three community cards, and (d-3) pooling player wagers for the third event and paying the pooled player wagers to the player having the highest 5-card poker rank using the player hands, the three community cards and the additional two community cards.

16. A method according to claim 15, wherein steps (d-1), (d-2) and (d-3) are practiced by pooling player wagers equal to an amount of a lowest player wager for each event, respectively, wherein wagers exceeding the lowest player wager are played against the dealer.

17. A method according to claim 15, wherein all player wagers are equal.

18. A method according to claim 1, wherein upon the event of a tie, step (d) is practiced by sharing a payout amongst the winning players.

19. A method according to claim 18, wherein odd chips resulting from a shared payout are processed according to predetermined rules.

20. A method of playing a casino game, comprising:
(a) receiving at least one competition wager from each player, the competition wager being without a house advantage;
(b) receiving a proposition wager from each player;
(c) a dealer dealing hands of playing cards to each player and a set of community cards to a community card area;
(d) resolving the or each competition wager according to a poker rank of one player hand against a poker rank of another player hand (1) after dealing playing cards to each player, and (2) after dealing the set of community cards to the community card area, respectively; and
(e) resolving the proposition wager according to the poker rank of each player hand against a payout scale.

21. A method according to claim 20, wherein the dealer is a player, and wherein step (d) is practiced by comparing the poker rank of each player hand against the dealer.

22. A method according to claim 20, wherein step (a) is practiced by receiving three competition wagers from each player corresponding to a first event, a second event, and a third event, and wherein step (c) is practiced by dealing 2-card hands of playing cards to each player as the first event, dealing a first set of community cards to the community card area as the second event, and dealing a second set of community cards to the community card area as the third event.

23. A method according to claim 22, wherein the three competition wagers from each player are of equal value.

24. A method according to claim 22, wherein the first set of community cards comprises three cards, and wherein the second set of community cards comprises two cards.

25. An apparatus for playing a casino game, comprising:
means for receiving a competition wager from each player, the competition wager being without a house advantage;
means for receiving a proposition wager from each player;
means for dealing hands of playing cards to each player and at least one least community card to a community card area;
means for resolving the competition wager according to a poker rank of one player hand against a poker rank of another player hand; and
means for resolving the proposition wager according to the poker rank of each player hand against a payout scale.
